(19) United States
(12) Patent Application Publication
(10) Pub. No.: US 2025/0045085 A1
(43) Pub. Date: Feb. 6, 2025

(54) EFFICIENT INPUT/OUTPUT (I/O) FOR NESTED VIRTUAL MACHINES WITH MEMORY OVERCOMMIT

(71) Applicant: RED HAT, INC., Raleigh, NC (US)

(72) Inventor: Michael Tsirkin, Yokneam Illit (IL)

(21) Appl. No.: 18/362,648

(22) Filed: Jul. 31, 2023

(51) Int. Cl. G06F 9/455

(52) U.S. Cl. CPC G06F 9/45558; G06F 2009/45583

(57) ABSTRACT

A method includes: running, by a host computer system, a hypervisor managing a first virtual machine, wherein the first virtual machine manages a second virtual machine; receiving, by the hypervisor, from a virtual device, a first request to perform a memory access operation with respect to a memory page of the second virtual machine; responsive to determining, by the hypervisor, that the memory page of the second virtual machine is unavailable in a memory of the first virtual machine, forwarding the first request to the first virtual machine; and responsive to detecting, by the hypervisor, a page fault with respect to the memory page, performing, by the hypervisor, the memory access operation with respect to the memory page of the second virtual machine.

### TECHNICAL FIELD

The present disclosure is generally related to virtualized computer systems, and more particularly, to efficient input/output (I/O) for nested virtual machines with memory overcommit.

### BACKGROUND

Virtualization allows multiplexing of an underlying host machine between different virtual machines. The virtualization is commonly provided by a hypervisor (e.g., virtual machine monitor (VMM)) and enables the hypervisor to allocate a certain amount of a host system's computing resources to each of the virtual machines. Each virtual machine is then able to configure and use virtualized computing resources (e.g., virtual processors) to execute executable code of a guest operating systems. A host machine can accommodate more virtual machines than the size of its physical memory allows, and give each virtual machine the impression that it has a contiguous address space, while in fact the memory used by the virtual machine may be physically fragmented and even overflow to disk storage.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example computer system that implements efficient input/output (I/O) for nested virtual machines with memory overcommit, in accordance with one or more aspects of the present disclosure;

FIG. 2 depicts a block diagram illustrating components of an example nested virtualization computer system performing efficient input/output (I/O) for nested virtual machines with memory overcommit, in accordance with one or more aspects of the present disclosure;

FIGS. 3 and 4 depict flow diagrams of example methods for implementing efficient input/output (I/O) for nested virtual machines with memory overcommit, in accordance with one or more aspects of the present disclosure;

FIG. 5 depicts a block diagram of an example computer system in accordance with one or more aspects of the present disclosure; and

FIG. 6 depicts a block diagram of an illustrative computing device operating in accordance with examples of the present disclosure.

### DETAILED DESCRIPTION

Described herein are systems and methods for implementing efficient input/output (I/O) for nested virtual machines with memory overcommit. Virtualization may be achieved by running a software layer, often referred to as “hypervisor,” above the hardware and below the virtual machines. A hypervisor may run directly on the server hardware without an operating system beneath it or as an application running under a traditional operating system. A hypervisor may abstract the physical layer and present this abstraction to virtual machines to use, by providing interfaces between the underlying hardware and virtual devices of virtual machines. A hypervisor is able to retain selective control of processor resources, physical memory, interrupt management, and input/output (I/O). Each virtual machine (VM) is a guest software environment that supports a stack consisting of operating system (OS) and application software. Each virtual machine operates independently of other virtual machines and uses the same interface to the processors, memory, storage, graphics, and I/O provided by a physical platform. The software executing in a virtual machine is executed at the reduced privilege level so that the hypervisor can retain control of platform resources. Processor virtualization may be implemented by the hypervisor scheduling time slots on one or more physical processors for a virtual machine, rather than a virtual machine actually having a dedicated physical processor. Memory virtualization may be implemented by employing a page table (PT) which is a memory structure translating virtual memory addresses to physical memory addresses. Device and input/output (I/O) virtualization involves managing the routing of I/O requests between virtual devices and the shared physical hardware.

Nested virtualization refers to running a virtual machine inside another virtualized environment. In nested virtualization, a hypervisor (“Level 0 hypervisor”) controls physical hardware resources (e.g., bare metal). One or more first virtualized environments (“Level 1 VM”) may run as virtual machine(s) managed by the Level 0 hypervisor. Each Level 1 VM may run its own set of virtual machines. These virtual machines can be referred to as Level 2 VMs. Each level indicates a ring of privilege and access to computing resources of a computer system, where Level 0 indicates a most privileged ring within an architecture of the computer system, and incremental levels indicate less privileged rings (e.g., Level 2 VM is less privileged that Level 1 VM). The Level 1 VM may control execution of the Level 2 VM(s).

I/O operations are typically performed via a peripheral device memory that is mapped to a physical address space (e.g., to a guest address space of a virtual machine). Thus, I/O operations should traverse two separate I/O stacks: one in the guest managing the virtual hardware and one in the hypervisor managing the physical hardware, in the nested virtualization, the routing of I/O requests involves multiple levels of guest-host communication for a I/O path. The long I/O path in nested virtualization affects both latency and throughput, and imposes additional CPU load. For example, when an application running within a Level 2 VM issues an I/O request, typically by making a system call, it is initially processed by the I/O stack in the guest operating system running within the Level 2 VM. A device driver in the Level 2 VM issues the request to a virtual I/O device, which the Level 1 VM then intercepts. The Level 1 VM issues another I/O request, typically by making another system call, it is initially processed by the I/O stack in the guest operating system running within the Level 1 VM. A device driver in the Level 1 VM issues the request to a virtual I/O device, which the Level 0 hypervisor then intercepts. The Level 0 hypervisor schedules requests from multiple VMs onto an underlying physical I/O device, usually via another device driver managed by the Level 0 hypervisor with direct access to physical hardware.

When a physical device finishes processing an I/O request, the two I/O stacks with multiple levels of guest-host communication should be traversed again in the reverse order. The actual device posts a physical completion interrupt, which is handled by the Level 0 hypervisor. The Level 0 hypervisor determines which Level 1 VM is associated with the completion and notifies Level 1 VM by posting a virtual interrupt for the virtual device managed by the guest operating system of Level 1 VM. The virtual device of Level 1 VM posts a virtual interrupt, which is handled by the Level 1 VM. The Level 1 VM determines which Level 2 VM is associated with the completion and notifies Level 2 VM by posting a virtual interrupt for the virtual device managed by the guest operating system of Level 2 VM.

To reduce overhead, some systems provide a passthrough mechanism, which provides a directed access from a virtual device of Level 0 hypervisor to the guest memory of Level 2 VM. The virtual machine can use the hardware devices bypassing all virtualization layers and without any software emulation, eliminating the processing overhead. However, because the Level 1 VM would be bypassed and thus unaware of some operations through the directed access, the Level 1 VM has to reserve the resources that have been allocated to Level 2 VM (e.g., pin the memory page of Level 2 VM in the memory of Level 1 VM), which means that the reserved resources, when not used by the Level 1 VM, cannot be efficiently used for another purpose. Preventing the Level 1 VM from using the resources efficiently can adversely affect the memory overcommit at the Level 1 VM. Memory overcommit refers to that the memory allocated to the virtual machine is more than the actual usage of the memory by the virtual machine such that unused portion of the memory can be assigned to other virtual machines for use.

Aspects of the present disclosure address the above-noted and other deficiencies by providing technology that implements efficient input/output (I/O) for nested virtual machines with memory overcommit. In particular, aspects of the present disclosure provide technology that allows memory overcommit at a Level 1 VM while still providing efficient I/O for Level 2 VM. In an example, the host computer system can run a Level 0 hypervisor managing a Level 1 VM, where Level 1 VM has control over the Level 2 VM. A virtual device of Level 0 hypervisor can request access to a guest memory of Level 2 VM to perform an I/O operation. To facilitate the efficient I/O, the Level 0 hypervisor can keep a list of memory pages, in the guest memory of Level 2 VM, that are available to the Level 1 VM (e.g., a memory page, of Level 2 VM, that is present in the memory of Level 1 VM). The memory page available to the Level 1 VM refers to that the content of memory page identified by the address(es) is loaded in the guest memory of Level 1 VM, and/or the content of the memory page identified by the address(es) is not in a protected mode (e.g., not encrypted).

In an illustrative example, a virtual device of Level 0 hypervisor can send, to the Level 2 VM, a request to perform an I/O operation that requires to access a memory page of Level 2 VM. The Level 0 hypervisor may check in the memory page list described above to determine whether the requested memory page matches a record in the memory page list. Responsive to finding no match of the requested memory page with a record in the memory page list, the Level 0 hypervisor may forward the request to the Level 1 VM. The Level 0 hypervisor may detect a page fault for the requested memory page. Detecting the page fault may cause the Level 1 VM to trigger a page fault for the requested memory page. Page faults occur when the Level 0 hypervisor attempts to access a memory page that is not currently loaded in the physical memory of the Level 1 VM or the memory page is currently loaded in the physical memory of the Level 1 VM but is in a protected mode and thus cannot be accessed. The Level 1 VM may handle the page fault by loading the content of the memory page into physical memory from a backing store and/or making the content of the memory page in an unprotected mode, e.g., by unencrypting. After loading data from backing store and/or making the content unencrypted, the Level 1 VM may notify the Level 0 hypervisor that the memory page is now available. As such, the Level 0 hypervisor can continue the process as specified in the request to perform the I/O operation without involving the Level 1 VM further. That is, the virtual device of the Level 0 hypervisor can access the memory page in the memory of the Level 2 VM to perform the I/O operation.

In some implementations, the virtual device is not part of the Level 0 hypervisor (i.e., the virtual device cannot be directly controlled by the Level 0 hypervisor). In such cases, the Level 0 hypervisor may send the list of memory pages, in the guest memory of Level 2 VM, that are available to the Level 1 VM to the virtual device. The virtual device may detect a page fault of the requested memory page and report the page fault to the Level 0 hypervisor. Then, the Level 0 hypervisor may cause the Level 1 VM to handle the page fault as described above so that the virtual device can, through the Level 0 hypervisor, access the memory page in the memory of the Level 2 VM to perform the I/O operation.

Aspects of the present disclosure present advantages of providing an efficient I/O for nested virtual machine and allowing the memory overcommit by the nested virtual machine. Aspects of the present disclosure reduces the overhead for I/O operations in the nested virtualization.

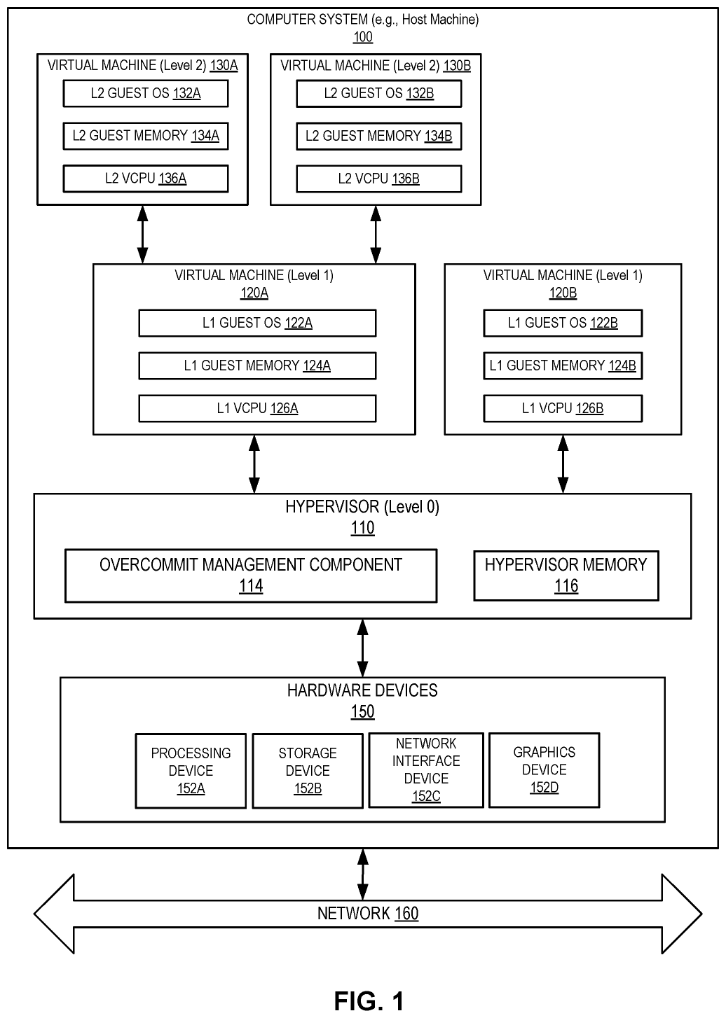

FIG. 1 depicts an illustrative architecture of elements of a computing system 100, in accordance with an embodiment of the present disclosure. Computing system 100 may be a single host machine or multiple host machines arranged in a heterogeneous or homogenous group (e.g., cluster) and may include one or more rack mounted servers, workstations, desktop computers, notebook computers, tablet computers, mobile phones, palm-sized computing devices, personal digital assistants (PDAs), etc. It should be noted that other architectures for computing system 100 are possible, and that the implementation of a computing system utilizing embodiments of the disclosure are not necessarily limited to the specific architecture depicted. In one example, computing system 100 may be a computing device implemented with x86 hardware. In another example, computing system 100 may be a computing device implemented with PowerPC®, SPARC®, or other hardware. In the example shown in FIG. 1, computing system 100 may include a Level 0 hypervisor 110, Level 1 VMs 120A-B, Level 2 VMs 130A-B, hardware devices 150, and a network 160.

Virtual machines 120A-B, 130A-B may execute guest executable code that uses an underlying emulation of the physical resources. The guest executable code may include a guest operating system, guest applications, guest device drivers, etc. Each of the virtual machines 120A-B, 130A-B may support hardware emulation, full virtualization, para-virtualization, operating system-level virtualization, or a combination thereof. Virtual machines 120A-B, 130A-B may have the same or different types of guest operating systems, such as Microsoft®, Windows®, Linux®, Solaris®, etc. Virtual machines 120A-B, 130A-B may execute guest operating systems 122A-B, 132A-B that manage guest memory 124A-B, 134A-B and virtual central processing units (vCPU) 126A-B, 136A-B respectively.

Guest memory 124A-B, 134A-B may be any virtual memory, logical memory, physical memory, other portion of memory, or a combination thereof for storing, organizing, or accessing data. Guest memory 124A-B, 134A-B may represent the portion of memory that is designated by hypervisors for use by one or more respective virtual machines 120A-B, 130A-B. Guest memory 124A-B, 134A-B may be managed by guest operating system 122A-B, 132A-B. Hypervisor memory 116 (e.g., host memory) may be the same or similar to the guest memory but may be managed by hypervisor 110 instead of a guest operating system. The memory allocated to guests may be a portion of hypervisor memory 116 that has been allocated by hypervisor 110 to virtual machines 120A-B, 130A-B and corresponds to guest memory of virtual machine 124A-B, 134A-B. Other portions of hypervisor memory may be allocated for use by hypervisor 110, a host operating system, hardware device, other module, or a combination thereof.

Hypervisor 110 may also be known as a virtual machine monitor (VMM) and may provide virtual machines 120A-B, 130A-B with access to one or more features of the underlying hardware devices 150. In the example shown, hypervisor 110 may run directly on the hardware of computer system 100 (e.g., bare metal hypervisor). In other examples, hypervisor 110 may run on or within a host operating system (not shown). Hypervisor 110 may manage system resources, including access to hardware devices 150, and may manage execution of virtual machines 120A-B, 130A-B on a host machine. This includes provisioning resources of a physical central processing unit (“CPU”) to each virtual machine 120A-B, 130A-B running on the host machine. Provisioning the physical CPU resources may include associating one or more vCPUs 126A-B, 136A-B with each virtual machine 120A-B, 130A-B. vCPU 126A-B, 136A-B may be provisioned by a core of the physical host CPU or a number of time slots reserved from one or more cores of the physical host CPU. Each of vCPU 126A-B, 136A-B may be implemented by a corresponding execution thread that is scheduled to run on a physical host CPU. Software executing in virtual machines 120A-B, 130A-B may operate with reduced privileges such that hypervisor 110 retains control over resources. Hypervisor 110 retains selective control of the processor resources, physical memory, interrupt management, and input/output (“I/O”).

In the shown example, virtual machine 120A is managed by hypervisor 110, and based on a request for a nested virtual machine 130A-B to be managed by virtual machine 120A, the hypervisor 110 creates a processing thread implementing a vCPU 136A associated with virtual machine 130A-B to be managed by virtual machine 120A. Accordingly, virtual machine 120A manages execution of virtual machine 130A-B allowing for pass through of devices and destruction of the processing thread of the virtual machine 130A thereby exerting control over virtual machine 130A-B.

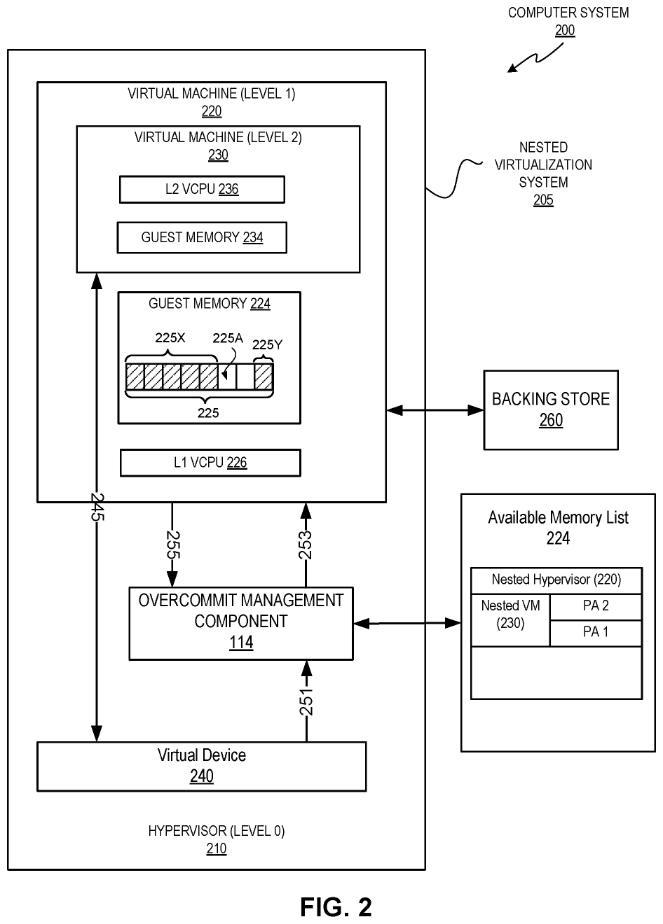

In the example shown, hypervisor 110 may include an overcommit management component 114. The overcommit management component 114 may enable nesting of virtual machines 130A-B in the virtual machine 120A and provide efficient I/O for virtual machines 130A-B. The overcommit management component 114 refers to a software component implemented by one or more software modules, where each module is associated with a set of executable instructions. Furthermore, the overcommit management component 114 is purely functional, i.e., overcommit management component 114 may be an integral part of the executable code of hypervisor 110. The details of overcommit management component 114 will be described with respect to FIGS. 2-6.

Hardware devices 150 may provide hardware resources and functionality for performing computing tasks. Hardware devices 150 may include one or more processing devices 152A, one or more storage devices 152B, one or more network interface devices 152C, one or more graphic device 152D, other computing devices, or a combination thereof. One or more of hardware devices 150 may be split up into multiple separate devices or consolidated into one or more hardware devices. Some of the hardware device shown may be absent from hardware devices 150 and may instead be partially or completely emulated by executable code.

Processing devices 152A may include one or more processors that are capable of executing the computing tasks. Processing devices 152A may be a single core processor that is capable of executing one instruction at a time (e.g., single pipeline of instructions) or may be a multi-core processor that simultaneously executes multiple instructions. The instructions may encode arithmetic, logical, or I/O operations. In one example, processing devices 152A may be implemented as a single integrated circuit, two or more integrated circuits, or may be a component of a multi-chip module (e.g., in which individual microprocessor dies are included in a single integrated circuit package and hence share a single socket). A processing device may also be referred to as a central processing unit (“CPU”).

Storage devices 152B may include any data storage device that is capable of storing digital data and may include volatile or non-volatile data storage. Volatile data storage (e.g., non-persistent storage) may store data for any duration of time but may lose the data after a power cycle or loss of power. Non-volatile data storage (e.g., persistent storage) may store data for any duration of time and may retain the data beyond a power cycle or loss of power. In one example, storage devices 152B may be physical memory and may include volatile memory devices (e.g., random access memory (RAM)), non-volatile memory devices (e.g., flash memory, NVRAM), and/or other types of memory devices. In another example, storage devices 152B may include one or more mass storage devices, such as hard drives, solid state drives (SSD)), other data storage devices, or a combination thereof. In a further example, storage devices 152B may include a combination of one or more memory devices, one or more mass storage devices, other data storage devices, or a combination thereof, which may or may not be arranged in a cache hierarchy with multiple levels.

Network interface device 152C may provide access to a network internal to the computing system 100 or external to the computing system 100 (e.g., network 160) and in one example may be a network interface controller (NIC). Graphics device 152D may provide graphics processing for the computing system 100 and/or one or more of the virtual machines 110. One or more of the hardware devices 150 may be combined or consolidated into one or more physical devices or may partially or completely emulated by hypervisor 110 as a virtual device.

Network 160 may be a public network (e.g., the internet), a private network (e.g., a local area network (LAN), a wide area network (WAN)), or a combination thereof. In one example, network 160 may include a wired or a wireless infrastructure, which may be provided by one or more wireless communications systems, such as a wireless fidelity (WiFi) hotspot connected with the network 140 and/or a wireless carrier system that can be implemented using various data processing equipment, communication towers, etc.

FIG. 2 is a block diagram illustrating example components and modules of computer system 200, in accordance with one or more aspects of the present disclosure. Computer system 200 may comprise executable code that implements one or more of the components and modules and may be implemented within a hypervisor, a host operating system, a guest operating system, hardware firmware, or a combination thereof. In the example shown, computer system 200 may include hypervisor 210, virtual machines 220 and 230, guest memory 224 and 234, and virtual device 240.

Nested virtualization system 205 may include virtual machine 220 (e.g., Level 1 VM) implemented with guest memory 220A (e.g., a portion of host memory of the hypervisor) and virtual physical device (e.g., resources of a physical device) provided by hypervisor 210. In some instances, all of the resources of the bare metal may be provided to hypervisor 210, or a subset of the bare metal resources may be provided to hypervisor 210.

Nested virtualization system 205 may run virtual machine 230 (e.g., Level 2 VM) in virtual machine 220 (e.g., Level 1 VM). Virtual machine 220 may create a nested virtual machine 230 of virtual machine 220. The virtual machine 220 may provide, to the newly created nested virtual machine 230, guest memory 230A. Guest memory 230A refers to a portion of guest memory 220A that has been exposed to the nested virtual machine 230.

In some implementations, a peripheral component interconnect (PCI) device assigned to a nested virtual machine (e.g., Level 2 VM) may be connected to a physical bus of the host machine, and the hypervisor may abstract the PCI device by assigning particular port ranges of the PCI device to the VM and presenting the assigned port ranges to the VM as a virtual device 240. The PCI device may be capable of direct memory access (DMA). DMA allows the PCI device to access the system memory for reading and/or writing independently of the central processing unit (CPU). PCI devices that are capable of performing DMA include disk drive controllers, graphics cards, network interface cards (NICs), sound cards, or any other input/output (I/O) device. While the hardware device is performing the DMA, the CPU can engage in other operations. In nested virtualization, a virtual device may be created and implemented by a nested hypervisor (e.g., the Level 1 hypervisor, a Level 2 hypervisor, etc.) and exposed to a VM (e.g., a Level 2 VM, a Level 3 VM running on a Level 2 hypervisor, etc.) as a pass-through device.

The overcommit management component 114 can keep a list of available memory pages of each nested virtual machine for each nested hypervisor and store the lists in the memory list 224. The available memory pages can be identified by an address (e.g., physical address or logical address) of a management unit (e.g., a memory page) or a range of addresses of management units (e.g., a range of memory pages) of the memory. In the example of FIG. 2, the overcommit management component 114 can store, in the memory list 224, multiple records, where each record includes an address (e.g., the address of memory page 225Y) or ranged addresses (e.g., the ranged addresses of memory pages 225X) of portions of the guest memory 234, where the portions are currently loaded in the guest physical memory of the virtual machine 220 and can be accessed (e.g., not encrypted, not in a protected mode, etc.). For example, the ranged memory pages 225X and the memory page 225Y are currently loaded in the guest physical memory of the virtual machine 220 and are not encrypted nor in a protected mode thus can be accessed.

In some implementations, the overcommit management component 114 can request the available e memory information from each nested hypervisor periodically or upon detecting a triggering event (e.g., a request to access a memory of nested virtual machine). In response, the nested hypervisor can send, to the overcommit management component 114, the information of guest memory of the corresponding nested virtual machine that is available to the nested hypervisor. In the example of FIG. 2, the overcommit management component 114 can request the accessible memory information from the virtual machine 220, and the virtual machine 220 transmits, to the overcommit management component 114, a list of the addresses of the guest memory 234 that is available to the virtual machine 220, which can include the ranged memory pages 225X and the memory page 225Y. As shown in FIG. 2, in some implementations, the available memory list 224 can provide, for a nested hypervisor (e.g., virtual machine 220), a list of the available guest memory (e.g., physical addresses PA1, PA2, etc.) of the nested virtual machine (e.g., virtual machine 230). Each list can include the available guest memory identified by a guest physical address of the guest memory 224, or a guest physical address of the guest memory 234 corresponding to the guest physical address of the guest memory 224, etc.

The overcommit management component 114 may detect a request 251 to perform an I/O operation that requires to access a memory page in the guest memory 234 of the virtual machine 230. The request 251 may specify an address of the guest address space of the virtual machine 230, where the address identifies the requested memory page. The overcommit management component 114 may search in the available memory list 224 to determine whether the requested memory page matches a record in the list of memory available to the virtual machine 220. Responsive to finding no match of the requested memory page with a record in the list of memory available to the virtual machine 220, the overcommit management component 114 may detect a page fault and forward the request as a request 253 (e.g., by generating an interrupt) requesting to access the memory page specified in request 251 to the virtual machine 220. Interrupts are events that indicate that a condition exists in the system, the processor, or within the currently executing task that requires attention of a processor. The action taken by the processor in response to an interrupt is referred to as servicing or handling the interrupt.

In some implementations, the overcommit management component 114 may detect a request from a virtual device that is not directly controlled by the hypervisor 210 to perform an I/O operation to access a memory page in the guest memory 234 of the virtual machine 230. In such situation, the overcommit management component 114 may send, to the virtual device, the list of available memory, so that the virtual device can generate a fault regarding the memory and report the fault to the overcommit management component 114.

Responsive to receiving the request 253, the hypervisor 210 may temporarily yielding execution control to the virtual machine 220 (e.g., via a VM Enter hardware event). The virtual machine 220 may trigger a page fault for the requested memory page. Page faults are used in a communication channel between a virtual machine and the hypervisor by modern computer systems that support hardware virtualization to indicate an access issue. Page faults occur when a nested hypervisor attempts to access a memory page that is not currently loaded in the physical memory of a nested virtual machine. As shown in FIG. 2, the page fault may be generated by a processor executing the hypervisor 210 and may be handled by the virtual machine 220. The virtual machine 220 may handle the page fault by loading the data into physical memory from a backing store. Page faults are typically handled transparent to the nested virtual machine (e.g., virtual machine 230) and the nested virtual machine may be unaware that the page fault occurred or was handled by the nested hypervisor (e.g., virtual machine 220).

Specifically, as described above, the process to handle the page fault may involve a transition VM enter or VM resume to put the virtual machine 220 to be active. A transition VM enter may refer to a transition to the reduced privilege execution level from the hypervisor context (i.e., privileged execution level) by executing a processor instruction (e.g., VMResume instructions) by the processor. A transition VM resume may involve a virtual machine running at the reduced privilege execution level that is idle, in which case to transition to the reduced privilege execution level from the hypervisor context by executing a processor instructions (e.g., VMEnter instructions), thus transferring the execution control to the virtual machine.

The virtual machine 220 may handle the page fault by making the memory page available to the hypervisor 210. In some implementations, the virtual machine 220 handles the page fault by loading the content of the memory page of the virtual machine 230 from a backing store 260 to the guest memory 224 of the virtual machine 220. Specifically, a page fault handler in the guest operating system of the virtual machine 220 find a free location, e.g., a free memory page in physical memory of the nested virtualization system 205, read the data from the backing store 260 into the free memory page, and add an entry to its location in the page table maintained by the memory management unit, and indicate that the memory page is loaded. As shown in FIG. 2, assuming that the memory page 225A is the memory page that is requested for the page fault but does not reside in the physical memory, the virtual machine 220 can have the memory page 225A loaded from the backing store 260 to be resident in the guest memory 224, and thus, the memory page 225A can be accessed.

In some implementations, the virtual machine 220 handles the page fault by unencrypting the content of the memory page of the virtual machine 230. Specifically, a page fault handler in the guest operating system of the virtual machine 220 find a key to unencrypt the content of the memory page, and indicate that the memory page 225A is unencrypted. As shown in FIG. 2, assuming that the memory page 225A is the memory page that is requested for the page fault and resides in the physical memory but is encrypted, the virtual machine 220 can have the memory page 225A unencrypted, and thus, the memory page 225A can be accessed.

After loading and/or unencrypting, the virtual machine 220 may trigger a transition VM exit to put the virtual machine 220 to sleep. A transition VM exit may refer to a transition from the reduced privilege execution level to the hypervisor context by executing a processor instruction (e.g., VMExit instructions). Accordingly, in nested virtualizations, when an interrupt occurs at the processor which is under the control of the Level 0 hypervisor and the Level 1 VM is idle, the Level 0 hypervisor injects the interrupt into the Level 1 VM causing a VMEnter from Level 0 hypervisor to Level 1 VM. The processor, after handling the page fault, subsequently injects another interrupt into Level 0 hypervisor from Level 1 VM causing a VMExit from Level 1 VM to transition the Level 1 VM into a sleep state. Injecting an interrupt may be performed by writing, into a memory buffer accessible by the destination virtual machine, a message specifying parameters of the interrupt.

In the example of FIG. 2, responsive to making the memory page available (e.g., loading the content of the memory page of the virtual machine 230 from the backing store 260 to be resident in the guest memory 224, or unencrypting the content of the memory page of the virtual machine 230), the virtual machine 230 may generate and send a response 255 to the overcommit management component 114, indicating the memory page is now available so that the hypervisor can handle the rest of the operation. As such, the hypervisor 210 can continue the process as specified in the request 251 to perform the I/O operation without involving the virtual machine 220 further.

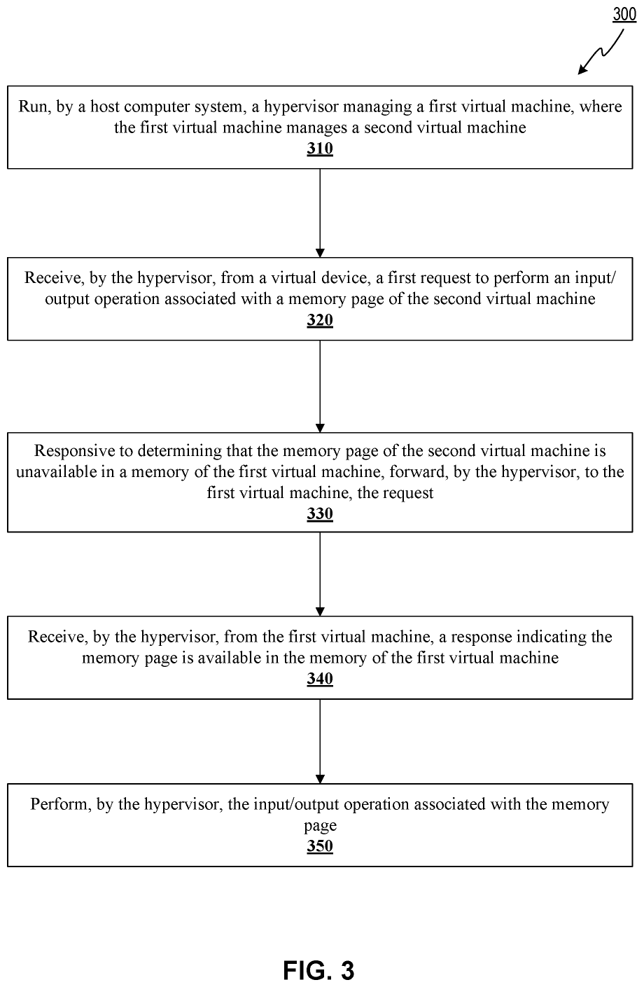

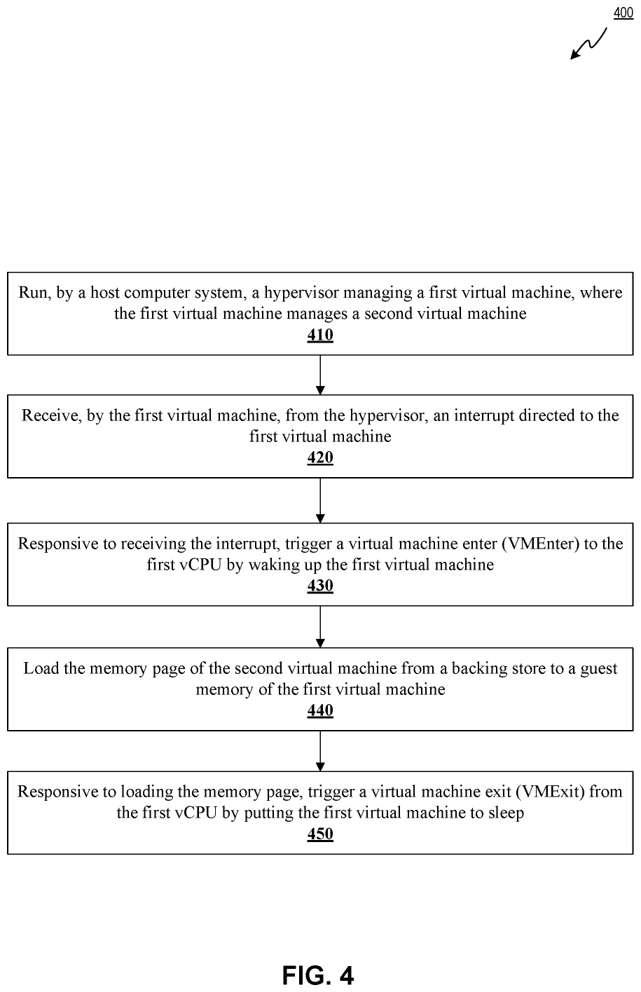

FIGS. 3 and 4 depict flow diagrams of illustrative examples of methods 300 and 400 for implementing efficient input/output (I/O) for nested virtual machines with memory overcommit, in accordance with one or more aspects of the present disclosure. Methods 300 and 400 each of its individual functions, routines, subroutines, or operations may be performed by one or more processors of the computer device executing the method. In certain implementations, methods 300 and 400 may be performed by a single processing thread. Alternatively, methods 300 and 400 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processes implementing methods 300 and 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, methods 300 and 400 may be performed by a kernel of a hypervisor as shown in FIG. 1 or by an executable code of a host machine (e.g., host operating system or firmware), a virtual machine (e.g., guest operating system or virtual firmware), an external device (e.g., a PCI device), other executable code, or a combination thereof.

Referring to FIG. 3, method 300 may be performed by processing devices of a hypervisor. At operation 310, a processing logic may run, through a host computer system, a hypervisor to manage a first virtual machine, wherein the first virtual machine manages a second virtual machine.

At operation 320, the processing logic may receive, by the hypervisor, from a virtual device, a first request to perform an input/output operation associated with a memory page of the second virtual machine.

At operation 330, responsive to determining that the memory page of the second virtual machine is unavailable in a memory of the first virtual machine, the processing logic may forward, by the hypervisor, to the first virtual machine, the first request for the memory page. In some implementations, the processing logic may determine whether the memory page of the second virtual machine is unavailable in a memory of the first virtual machine. In some implementations, the processing logic may detect a page fault for the memory page responsive to determining that the memory page of the second virtual machine is unavailable in a memory of the first virtual machine. In some implementations, determining that the memory page of the second virtual machine is unavailable in a memory of the first virtual machine includes determining that the memory page resides in a backing store and/or determining that the memory page is encrypted.

In some implementations, the processing logic may maintain, by the hypervisor, a memory page list, where the memory page list comprises a plurality of records, wherein each record of the plurality of records specifies an address of a particular memory page of the second virtual machine, where the particular memory page is available in the memory of the first virtual machine. In some implementations, the processing logic may determine that the memory page of the second virtual machine does not match any record of the plurality of records in the memory page list.

In some implementations, the virtual device is directly controlled by the hypervisor and the processing logic may detect a page fault responsive to determining that the memory page of the second virtual machine is unavailable in a memory of the first virtual machine by searching the memory page list described above. In some implementations, the virtual device is not directly controlled by the hypervisor and the processing logic may detect a page fault by sending the memory page list to the virtual device and receiving the page fault from the virtual device, where the virtual device generates the page fault.

At operation 340, the processing logic may receive, by the hypervisor, from the first virtual machine, a response indicating the memory page is now available in the memory of the first virtual machine. In some implementations, the processing logic, responsive to detecting the page fault, may trigger the page fault to load the memory page from a backing store to the memory of the first virtual machine. In some implementations, the processing logic, responsive to detecting the page fault, may trigger the page fault to unencrypt the memory page. In some implementations, the processing logic may detect the page fault responsive to the first virtual machine triggering the page fault to unencrypt the memory page.

At operation 350, the processing logic may perform, by the hypervisor, the input/output operation associated with the memory page. Performing the input/output operation is achieved without involving the first virtual machine. In some implementations, the processing logic, responsive to detecting the page fault and that the page fault is handled, may perform, by the hypervisor, the memory access operation with respect to the memory page of the second virtual machine. In some implementations, the processing logic may communicate, by the hypervisor, with the second virtual machine, a first response to the first request indicating the performance of the input/output operation associated with the memory page.

Referring to FIG. 4, method 400 may be performed by processing devices of a virtual machine. At operation 410, the processing logic may run, through a host computer system, a hypervisor to manage a first virtual machine associated with a first virtual processor (vCPU), where the first virtual machine manages a second virtual machine associated with a second vCPU. At operation 420, the processing logic may receive, by the first virtual machine, from the hypervisor, an interrupt directed to the first virtual machine. The interrupt may be part of a forwarded request, where the forwarded request is a request by a virtual device to perform a memory access operation with respect to a memory page of the second virtual machine, where the memory page is determined to be unavailable in a memory of the first virtual machine. At operation 430, in response to receiving an interrupt directed to the first virtual machine, the processing logic may trigger a virtual machine enter (VMEnter) to the first vCPU by transitioning the first processing thread to an active state. At operation 440, the processing logic may load the memory page of the second virtual machine from a backing store to a guest memory of the first virtual machine. At operation 450, in response to loading the memory page, the processing logic may trigger a virtual machine exit (VMExit) from the first vCPU by putting the first processing thread in a sleep state.

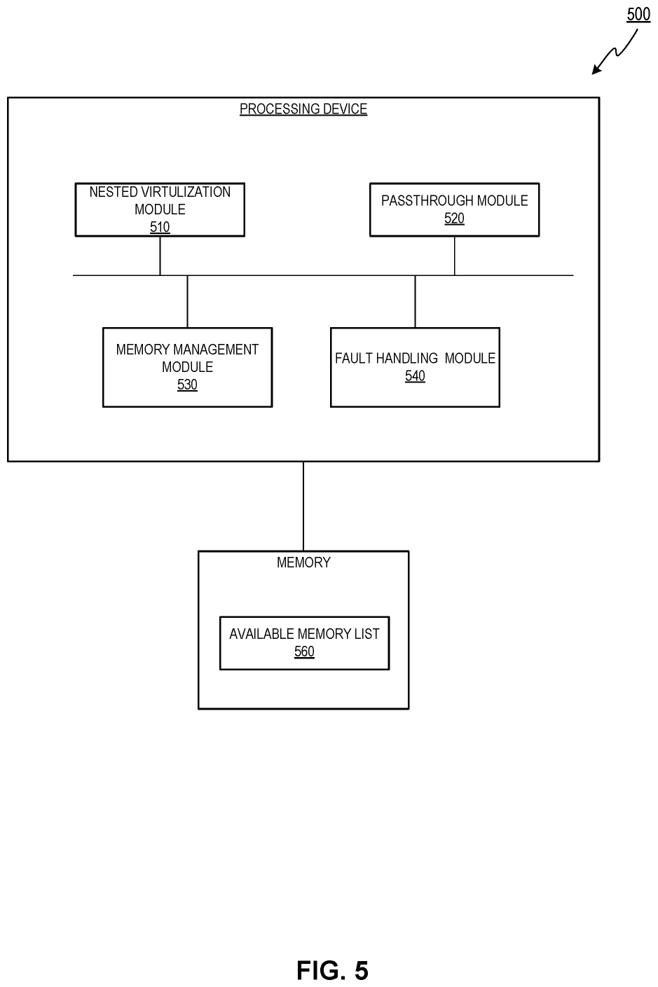

FIG. 5 depicts a block diagram of a computer system 500 operating in accordance with one or more aspects of the present disclosure. Computer system 500 may be the same or similar to computing system 100 of FIG. 1, or computing system 200 of FIG. 2, and may include one or more processors and one or more memory devices. In the example shown, computer system 500 may include a nested virtualization module 510, a passthrough module 520, a memory management module 530, fault handling module 540, and an accessible memory list 560.

Nested virtualization module 510 may enable a processor to run a hypervisor managing a first virtual machine associated with a first virtual processor in which the first virtual machine manages a second virtual machine. As previously described, the hypervisor controls physical hardware resources (e.g., bare metal) and the first virtual machine runs as a virtual machine managed by the hypervisor. The first virtual machine can run its own set of virtual machines, such as, the second virtual machine.

Passthrough module 520 may enable a processor to have the second virtual machine communicate directly with a virtual device of the hypervisor. When the second virtual machine communicates with a virtual device of the hypervisor, the portion of the guest memory of the first virtual machine that is exposed to the second virtual machine become inaccessible to other process, so that the second virtual machine can exclusively use the portion to perform the I/O operation, which prevents the first virtual machine from memory overcommit.

Memory management module 530 may enable a processor to enable the memory overcommit of the guest memory of the first virtual machine. Enabling the memory overcommit of the guest memory of the first virtual machine allows portions of the guest memory that is reserved for the second virtual machine to be allocated for other use that is not associated with the second virtual machine.

Fault handling module 540 may enable the processor, in response to receiving, by the hypervisor, a request to access a memory page of a guest memory of the second virtual machine, determine whether the memory page is available to the hypervisor. Fault handling module 540 may enable the processor to determine that the requested memory page is not available by searching in the available memory list 560. Fault handling module 540 may enable the processor to detect a page fault for the requested memory page and generate an interrupt directed to the first virtual machine and injects it into the first vCPU of the first virtual machine in which the first virtual machine processes the interrupt. In one implementation, the interrupt causes a VMEnter to the first virtual machine.

The fault handling module 530 may enable the processor to handle a page fault by loading the content of the requested memory page from a backing store to the guest memory of the first virtual machine and/or by making the memory page unencrypted. Specifically, a page fault handler in the guest operating system of the virtual machine find a free location, e.g., a free memory page in physical memory of the nested virtualization system, read the data from the backing store into the free memory page, and add an entry to its location in the page table maintained by the memory management unit, and indicate that the memory page is loaded.

The fault handling module 530 may enable the processor, in response to loading the memory page to generate another interrupt. For example, the first processing thread generates another interrupt directed to the hypervisor and injects it into the CPU of the hypervisor in which the hypervisor processes the interrupt. In one implementation, the interrupt cause a VMExit to the hypervisor. The fault handling module 530 may enable the processor to generate a response indicating that the requested memory page is now available to the hypervisor, and hypervisor may then continue handling the I/O operation requested by the virtual disk to access the memory page of the second virtual machine.

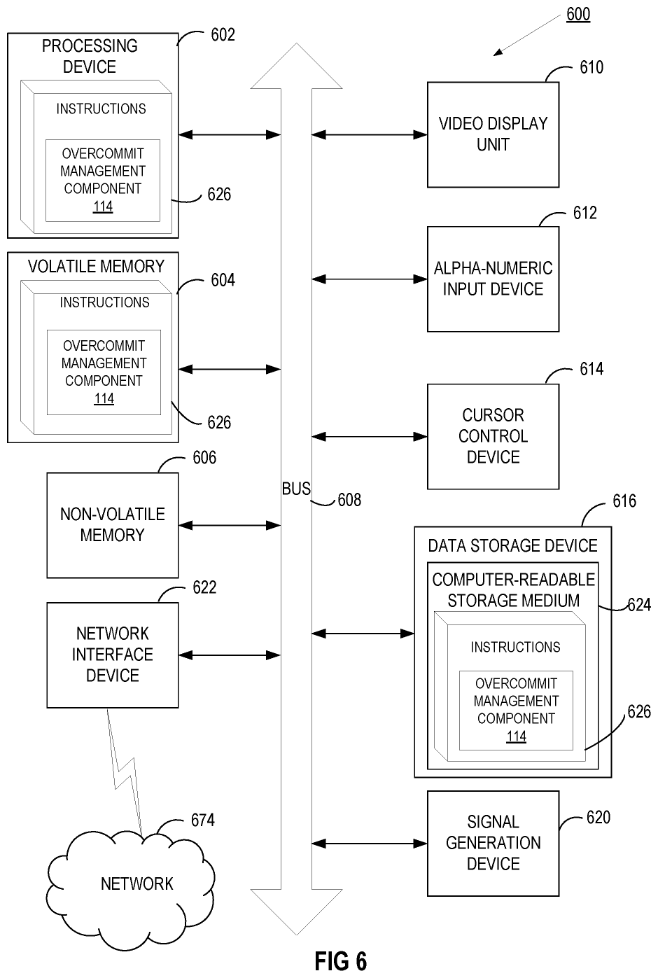

FIG. 6 depicts a block diagram of a computer system operating in accordance with one or more aspects of the present disclosure. In various illustrative examples, computer system 600 may correspond to computing device 100 of FIG. 1 and computing device 200 of FIG. 200. Computer system 600 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for implementing method 300 or 400 and for encoding components implemented on FIG. 1 and FIG. 6.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “running,” “receiving,” “determining,” “forwarding,” “detecting,” “performing,” “maintaining,” “sending,” “triggering,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 or 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
running, by a host computer system, a hypervisor managing a first virtual machine, wherein the first virtual machine manages a second virtual machine;
receiving, by the hypervisor, from a virtual device, a first request to perform a memory access operation with respect to a memory page of the second virtual machine;
responsive to determining, by the hypervisor, that the memory page of the second virtual machine is unavailable in a memory of the first virtual machine, forwarding the first request to the first virtual machine; and
responsive to detecting, by the hypervisor, a page fault with respect to the memory page, performing, by the hypervisor, the memory access operation with respect to the memory page of the second virtual machine.

2. The method of claim 1, wherein responsive to detecting the page fault, the hypervisor causes the first virtual machine to make the memory page available in the memory of the first virtual machine.

3. The method of claim 1, further comprising:
maintaining, by the hypervisor, a memory page list, wherein the memory page list comprises a plurality of records, wherein each record of the plurality of records specifies an address of a particular memory page of the second virtual machine, wherein the particular memory page is available in the memory of the first virtual machine.

4. The method of claim 3, wherein determining that the memory page of the second virtual machine is not available in the memory of the first virtual machine further comprises:
determining that the memory page of the second virtual machine does not match any record of the plurality of records in the memory page list.

5. The method of claim 1, wherein the virtual device is directly controlled by the hypervisor.

6. The method of claim 3, wherein the virtual device is not directly controlled by the hypervisor, and wherein detecting the page fault further comprises:
sending the memory page list to the virtual device; and
receiving the page fault from the virtual device.

7. The method of claim 1, wherein detecting the page fault causes the first virtual machine to trigger the page fault to load the memory page from a backing store to the memory of the first virtual machine.

8. The method of claim 1, wherein determining that the memory page of the second virtual machine is unavailable further comprises determining that the memory page is encrypted.

9. The method of claim 8, wherein detecting the page fault causes the first virtual machine to trigger the page fault to unencrypt the memory page.

10. The method of claim 8, wherein detecting the page fault is performed responsive to the first virtual machine triggering the page fault to unencrypt the memory page.

11. A system comprising:
a memory device;
a processing device operatively coupled to the memory device, to perform operations comprising:
running, by a host computer system, a hypervisor managing a first virtual machine, wherein the first virtual machine manages a second virtual machine;
receiving, by the hypervisor, from a virtual device, a first request to perform a memory access operation with respect to a memory page of the second virtual machine;
responsive to determining, by the hypervisor, that the memory page of the second virtual machine is unavailable in a memory of the first virtual machine, forwarding the first request to the first virtual machine; and
responsive to detecting, by the hypervisor, a page fault with respect to the memory page, performing, by the hypervisor, the memory access operation with respect to the memory page of the second virtual machine.

12. The system of claim 11, wherein responsive to detecting the page fault, the hypervisor causes the first virtual machine to make the memory page available in the memory of the first virtual machine.

13. The system of claim 11, wherein the operations further comprise:
maintaining, by the hypervisor, a memory page list, wherein the memory page list comprises a plurality of records, wherein each record of the plurality of records specifies an address of a particular memory page of the second virtual machine, wherein the particular memory page is available in the memory of the first virtual machine.

14. The system of claim 13, wherein determining that the memory page of the second virtual machine is not available in the memory of the first virtual machine further comprises:
determining that the memory page of the second virtual machine does not match any record of the plurality of records in the memory page list.

15. The system of claim 11, wherein the virtual device is directly controlled by the hypervisor.

16. The system of claim 13, wherein the virtual device is not directly controlled by the hypervisor, and wherein detecting the page fault further comprises:
sending the memory page list to the virtual device; and
receiving the page fault from the virtual device.

17. A non-transitory machine-readable storage medium including instructions that, when accessed by a processing device, cause the processing device to perform operations comprising:
running, by a host computer system, a hypervisor managing a first virtual machine, wherein the first virtual machine manages a second virtual machine;
receiving, by the hypervisor, from a virtual device, a first request to perform a memory access operation with respect to a memory page of the second virtual machine;
responsive to determining, by the hypervisor, that the memory page of the second virtual machine is unavailable in a memory of the first virtual machine, forwarding the first request to the first virtual machine; and
responsive to detecting, by the hypervisor, a page fault with respect to the memory page, performing, by the hypervisor, the memory access operation with respect to the memory page of the second virtual machine.

18. The non-transitory machine-readable storage medium of claim 17, wherein responsive to detecting the page fault, the hypervisor causes the first virtual machine to make the memory page available in the memory of the first virtual machine.

19. The non-transitory machine-readable storage medium of claim 17, wherein the operations further comprise:
maintaining, by the hypervisor, a memory page list, wherein the memory page list comprises a plurality of records, wherein each record of the plurality of records specifies an address of a particular memory page of the second virtual machine, wherein the particular memory page is available in the memory of the first virtual machine.

20. The non-transitory machine-readable storage medium of claim 19, wherein determining that the memory page of the second virtual machine is not available in the memory of the first virtual machine further comprises:
determining that the memory page of the second virtual machine does not match any record of the plurality of records in the memory page list.
